(19) United States
(12) Patent Application Publication
(10) Pub. No.: US 2002/0179236 A1
(43) Pub. Date: Dec. 5, 2002

(54) System and method for curing reactive material

(76) Inventors: Patrick O'Connor, Toronto (CA); John J. Kuta, Mississauga (CA)

Correspondence Address: Shawn D. Jacka, Bereskin & Parr, Box 401, 40 King Street West, Toronto, ON, M5H 3Y2, CA

(21) Appl. No.: 09/873,199

(22) Filed: Jun. 5, 2001

(51) Int. Cl. B29D 11/00

(52) U.S. Cl. 156/275.7; 427/163.2; 156/304.2; 425/174.4; 264/1.27

(57) ABSTRACT

A method and system for curing reactive material. The system includes an inlet port adapted to receive radiation from a source, a plurality of emitter ports and transmission means operatively coupling the inlet port to each emitter port. The transmission means is adapted to conduct radiation from the inlet port to the emitter ports and preferably includes a plurality of optical fibre strands. Additionally, the system also preferably includes a housing defining a substantially tubular irradiation chamber. In one embodiment, a method is disclosed for joining the ends of a first optical cable and a second optical cable together. The method includes the steps of abutting the end of the first optical cable to the end of the second optical cable, applying reactive adhesive to the abutted ends, and directing radiation within the absorption spectrum of the reactive adhesive onto the adhesive until the adhesive is sufficiently cured. Preferably, the curing step involves positioning the abutted ends within the irradiation chamber of the curing system of the present invention. In another embodiment, a method is disclosed for coating fibre optic cabling. The method includes the steps of applying reactive coating material to the outside of the fibre optic cabling, and directing radiation within the absorption spectrum of the reactive adhesive onto the coating material until the coating material is sufficiently cured.

### FIELD OF THE INVENTION

The present invention relates generally to the field of curing polymeric materials, with common but by no means exclusive application to manufacturing techniques for the joining of fibre optic cables using reactive adhesives. For greater clarity, when used herein, reference to “curable” and “reactive” materials and variations thereof is intended to mean polymeric materials which chemically transform with the application of sufficient energy, unless a contrary intention is apparent.

### BACKGROUND OF THE INVENTION

Fiber optic cabling is used extensively in high-speed communications networks. However, given the necessity of maintaining maximum optical transmission, coating and joining or “splicing” segments of fiber optic cabling to repair or extend the cabling, can prove difficult.

Accordingly, the inventors have recognized a need for a system and method which are capable of efficiently coating and joining segments of fiber optic cabling.

### SUMMARY OF THE INVENTION

This invention is directed towards a system for curing reactive material.

The system includes an inlet port adapted to receive radiation from a source, a plurality of emitter ports and transmission means operatively coupling the inlet port to each emitter port. The transmission means is adapted to conduct radiation from the inlet port to the emitter ports. The transmission means preferably includes a plurality of optical fibre strands. Additionally, the system also preferably includes a housing defining a substantially tubular irradiation chamber.

In another aspect, the invention is also directed towards a system for curing reactive material. The system includes an inlet port adapted to receive radiation from a source, at least one emitter port, and transmission means operatively coupling the inlet port to each emitter port. The transmission means is adapted to conduct radiation from the inlet port to the emitter ports. Preferably, the emitter port is configured in a shape approximating the surface area of a portion of a workpiece to be cured.

The invention is further directed towards a method for joining a first optical cable having an end to a second optical cable having an end. The method includes the steps of:

(a) abutting the end of the first optical cable to the end of the second optical cable;

(b) applying reactive adhesive to the abutted ends; and

(c) directing radiation within the absorption spectrum of the reactive adhesive onto the adhesive until the adhesive is sufficiently cured.

Preferably, step (c) involves positioning the abutted ends within the irradiation chamber of the curing system of the present invention.

The invention is yet further directed towards a method for coating fibre optic cabling. The method includes the steps of:

(a) applying reactive coating material to the outside of the fibre optic cabling ; and

(b) directing radiation within the absorption spectrum of the reactive adhesive onto the coating material until the coating material is sufficiently cured.

Preferably, step (b) involves positioning the coated fibre optic cabling within the irradiation chamber of the curing system of the present invention.

### BRIEF DESCRIPTION OF THE DRAWINGS

The present invention will now be described, by way of example only, with reference to the following drawings, in which like reference numerals refer to like parts and in which:

FIG. 1A is a top perspective view of a first embodiment of the curing system made in accordance with the present invention.

FIG. 1B is an expanded view of the input port of the curing system of FIG. 1A.

FIG. 2 is a cross-sectional view of the curing system of FIG. 1A with the optical fibre filaments removed.

FIG. 3 is an expanded view of an emitter port of the curing system of FIG. 1A.

FIG. 4 is a top perspective view of a second embodiment of the curing system made in accordance with the present invention.

FIG. 5 is a logical flow diagram of a first curing method carried out by the curing system made in accordance with the present invention.

FIG. 6 is a logical flow diagram of a second curing method carried out by the curing system made in accordance with the present invention.

### DESCRIPTION OF THE PREFERRED EMBODIMENTS

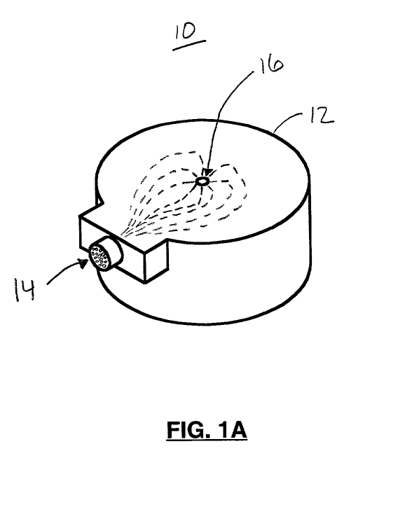

Referring simultaneously to FIGS. 1A and 1B, illustrated therein is a first embodiment of the curing system of the subject invention. The curing system, shown generally as 10, includes a housing 12, an inlet port 14 and an irradiation chamber 16.

The housing 12 is typically made of metal or other material selected to be largely unaffected by the heat generated by the curing process. The housing 12 is generally cylindrical; however, as will be understood, alternate configurations of the housing 12 may be used depending on the requirements of the curing application.

As illustrated in FIG. 1B, optical fibre filaments 18, typically approximately 245 micrometers in diameter are compressed in the mouth of the inlet port 14 and adhered together. The ends of the filaments 18 are ground and polished smooth to maximize optical transmission from a radiation source (typically a standard light guide). The inlet port 14 is generally circular in shape, and preferably configured to mate with the metal ferrule of a standard light guide, using a coupler, as will be understood. Preferably the fibre filaments 18 are made of quartz or other standard optical fibre material, adapted to receive and transmit radiation suitable for curing reactive materials.

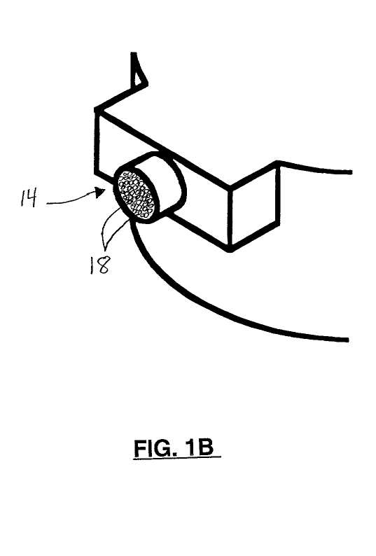

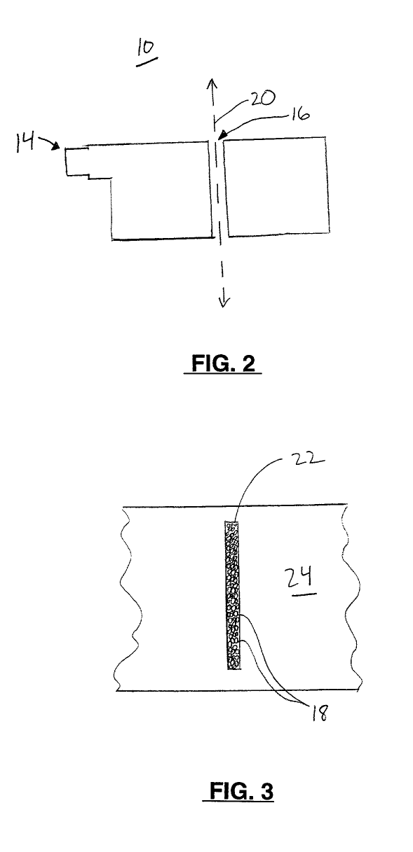

Referring now to FIGS. 2 and 3, the housing 12 defines an irradiation chamber 16 which is generally tubular about a central axis 20, and circular in cross-section. Preferably the irradiation chamber 16 is sized to receive a standard fibre optic bundle for curing. Standard fibre optic bundles are typically 3, 5 or 8 mm in diameter. Eight emitter ports 22 are positioned on the interior wall 24 of the irradiation chamber 16, evenly spaced in a circle about the central axis.

The emitter ports 22 are adapted to direct radiation radially towards the central axis 20. Preferably the emitter ports 22 are shaped and positioned on the interior wall 24 in order to provide irradiation generally in a 360° arc around the central axis 20, to ensure even distribution of curing radiation about the object to be cured. Each emitter port 22 is substantially rectangular in shape, with the width of the port 22 sufficiently small in relation to the length that the port 22 is substantially linear in appearance.

The second end of each emitter fibre 18 terminates at an emitter port 22, where it is compressed into the shape of the emitter port 22 and adhered to the other fibres 18 at that emitter port 22. As with the inlet port 14, the ends of the fibres 18 are ground and polished smooth to maximize optical transmission. The optical fibres 18 function to transmit radiation received from a radiation source at the inlet port 14 to the emitter ports 22.

Since the radiation source may not provide radiation uniformly into the inlet port 14, it is preferable if the second ends of the optical fibre filaments 18 are randomly distributed between the various emitter ports 22, once the first ends are positioned at the inlet port 14. Random distribution of the fibre filaments 18 will help ensure that the radiation emitted by the various emitter ports 22 is substantially uniform, as will be understood. The eight bundles of optical fibre filaments 18 corresponding to each emitter port 22 are housed within the housing 12, and are illustrated schematically as dotted lines on FIG. 1A.

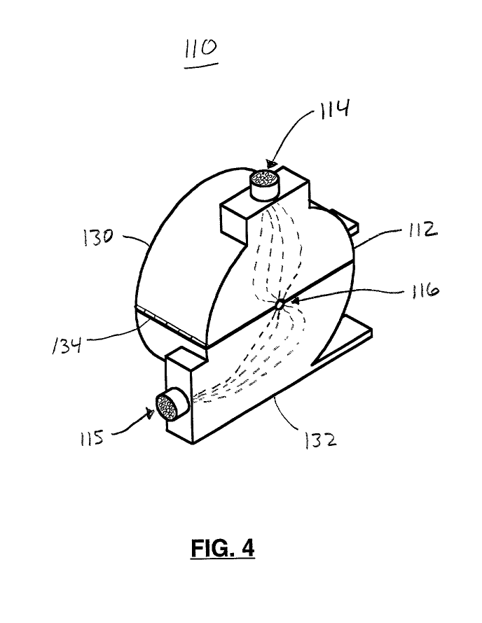

Illustrated in FIG. 4 is a second embodiment of the curing system of the subject invention. The second embodiment, shown generally as 110, includes a housing 112, a first inlet port 114, a second inlet port 115 and an irradiation chamber 116.

The housing 112 is divided into a first segment 130 on which the first inlet port 114 is located, and a second segment 132 on which the second inlet port 115 is located. The two segments 130, 132 are joined by a hinge 134. Each segment 130, 132 defines a portion of the irradiation chamber 116. As will be understood, the hinge 134 enables the two segments 130, 132 to be positioned in an open position to enable easy access to the irradiation chamber 116 for positioning objects to be cured and removing them afterwards. The segments 130, 132 can then be closed together for the curing process. This hinged configuration is particularly useful when continuously curing the coating of long sections of fibre optic cabling, the method of which is discussed below.

The inlet ports 114, 115 are generally similar to the inlet port 14, and the irradiation chamber 116 also has eight emitter ports (not shown), which are similar to the emitter ports 22 of the first embodiment 10, with differences which will be apparent. The first inlet port 114 is coupled by bundles of emitter fibre filaments (illustrated by the corresponding dotted lines on FIG. 4) to the four emitter ports on the first housing segment's interior wall of the irradiation chamber 116. Similarly, the second inlet port 115 is coupled by bundles of emitter fibre filaments to the four emitter ports on the second housing segment's interior wall of the irradiation chamber 116.

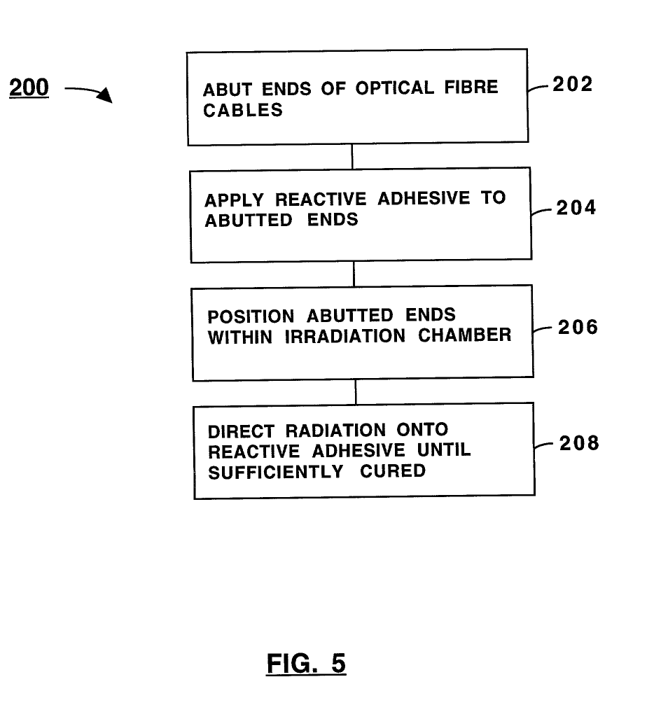

FIG. 5 illustrates the steps of the method 200 carried out by the curing system 10, 110 in use and made in accordance with the subject invention. The user typically first abuts the ends of two optical fibre cables which are to be joined together. (Block 202) Reactive adhesive is then applied to the abutted ends. (Block 204) The abutted ends are then positioned within the irradiation chamber. (Block 206) Radiation is then directed into the inlet port(s) and transmitted out the emitter ports until the adhesive is sufficiently cured. (Block 208)

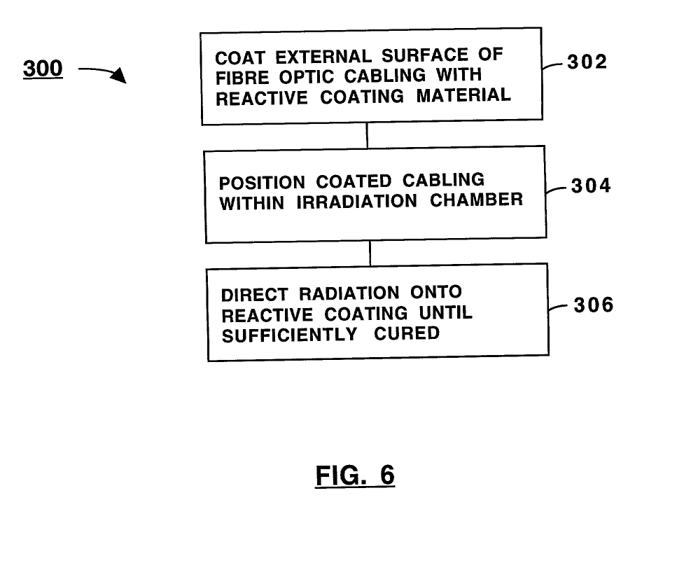

FIG. 6 illustrates the steps of the method 300 carried out by the curing system 10, 110 in use and made in accordance with the subject invention. The user typically first coats the external surface of fibre optic cabling with reactive coating material. (Block 302) The coated cabling is then positioned within the irradiation chamber. (Block 304) Radiation is then directed into the inlet port(s) and transmitted out the emitter ports until the coating is sufficiently cured. (Block 306) As will be understood, the coating and curing steps may be carried out as a continuous process with the cabling advancing at a steady rate through a coating apparatus, and through the irradiation chamber.

As will be understood, while the irradiation chambers 16, 116 have been disclosed as being tubular and circular in cross-section, it should be understood that different configurations are possible, including for curing applications other than the joining of fiber optic cables using reactive adhesive. Additionally, while the two embodiments 10, 110 have been illustrated as having eight evenly spaced emitter ports in their irradiation chambers, it should be understood that other numbers and configurations of emitter ports are possible, as long as sufficient radiation is directed onto the object to be cured.

Thus, while what is shown and described herein constitute preferred embodiments of the subject invention, it should be understood that various changes can be made without departing from the subject invention, the scope of which is defined in the appended claims.

We claim:

1. A system for curing curable material, the system comprising:
(a) an inlet port adapted to receive radiation from a source;
(b) a plurality of emitter ports;
(c) transmission means operatively coupling the inlet port to each emitter port;
(d) wherein the transmission means is adapted to conduct radiation from the inlet port to the emitter ports.

2. The system as claimed in claim 1, wherein the inlet port is adapted to receive the emitting end of a light guide.

3. The system as claimed in claim 1, wherein the inlet port is adapted to releasably engage a metal ferrule of a light guide.

4. The system as claimed in claim 1, wherein the emitter ports are configured substantially in a circle.

5. The system as claimed in claim 4, wherein each emitter port is configured to emit radiation substantially radially.

6. The system as claimed in claim 1 further comprising a housing, and wherein the housing defines a substantially tubular irradiation chamber having an interior wall.

7. The system as claimed in claim 6, wherein the emitter ports are positioned on the interior wall of the irradiation chamber.

8. The system as claimed in claim 7, wherein the emitter ports are configured to provide irradiation in a substantially 360° arc.

9. The system as claimed in claim 7, wherein the housing comprises:
(a) a first housing segment comprising a first portion of the irradiation chamber; and
(b) a second housing segment comprising a second portion of the irradiation chamber.

10. The system as claimed in claim 9, wherein the first housing segment is operatively coupled to the second housing segment by a hinge.

11. The system as claimed in claim 9, further comprising a second inlet port adapted to receive radiation from a second source.

12. The system as claimed in claim 11, wherein the first housing segment comprises at least one emitter port, and wherein the second housing segment comprises at least one emitter port.

13. The system as claimed in claim 1, wherein the transmission means comprises a plurality of optical fibre strands.

14. The system as claimed in claim 13, wherein each optical fibre strand comprises a first end positioned proximate the inlet port, and a second end positioned proximate an emitter port.

15. The system as claimed in claim 14, wherein the second end of each optical fibre strand is substantially randomly assigned to an emitter port.

16. The system as claimed in claim 1, wherein the emitter ports are substantially linear in shape.

17. The system as claimed in claim 6, wherein the irradiation chamber is configured to receive a fibre optic bundle.

18. A system for curing reactive material, the system comprising:
(a) an inlet port adapted to receive radiation from a source;
(b) at least one emitter port;
(c) transmission means operatively coupling the inlet port to each emitter port; and
(d) wherein the transmission means is adapted to conduct radiation from the inlet port to the emitter ports.

19. A method for joining a first optical cable having an end to a second optical cable having an end, the method comprising the steps of:
(a) abutting the end of the first optical cable to the end of the second optical cable;
(b) applying reactive adhesive to the abutted ends; and
(c) directing radiation within the absorption spectrum of the reactive adhesive onto the adhesive until the adhesive is sufficiently cured.

20. The method as claimed in claim 19, wherein step (c) comprises positioning the abutted ends within a substantially tubular irradiation chamber of a curing system.

21. A method for coating fibre optic cabling, the method comprising the steps of:
(a) coating the external surface of the fibre optic cabling with coating material; and
(b) directing radiation within the absorption spectrum of the reactive coating material onto the adhesive until the coating material is sufficiently cured.

22. The method as claimed in claim 21, wherein step (b) comprises positioning the coated cabling within a substantially tubular irradiation chamber of a curing system.
